(19) United States
(12) Patent Application Publication
(10) Pub. No.: US 2024/0182047 A1
(43) Pub. Date: Jun. 6, 2024

(54) AUTOMATED DRIVING SYSTEM

(71) Applicant: TOYOTA JIDOSHA KABUSHIKI KAISHA, Toyota-shi (JP)

(72) Inventor: Takaki NAKAGAWA, Seto-shi (JP)

(73) Assignee: TOYOTA JIDOSHA KABUSHIKI KAISHA, Toyota-shi (JP)

(21) Appl. No.: 18/360,035

(22) Filed: Jul. 27, 2023

(30) Foreign Application Priority Data
Dec. 5, 2022 (JP) 2022-194092

(51) Int. Cl. B60W 50/02; B60W 60/00; G01C 21/34

(52) U.S. Cl. CPC B60W 50/0225; B60W 50/0205; B60W 60/001; G01C 21/3484

(57) ABSTRACT

Determination on impossibility of automated driving along a predetermined travel route is performed at an early stage. A vehicle's heat dissipation performance (a value of a vehicle performance parameter correlating to a vehicle performance used to determine whether the automated driving is possible) and an amount of heat dissipation required to implement the automated driving of the vehicle along the travel route (a value of a necessary performance parameter correlating to the vehicle performance required to implement the automated driving of the vehicle along the travel route) are estimated. If the value of the vehicle performance parameter is less than the value of the necessary performance parameter, the automated driving of the vehicle along the predetermined travel route is determined non-executable, and any of the following is performed: setting of another travel route; return of the vehicle to the repair shop; or evacuation of the vehicle.

### TECHNICAL FIELD

This invention relates to an automated driving system.

### BACKGROUND ART

In recent years, automated driving systems have been developed to drive vehicles automatically. Conventional automated driving systems control the vehicle to evacuate (e.g., drive to the shoulder of the road) and then stop when the automated driving along a predetermined driving route becomes impossible. When the vehicle is stopped, occupants cannot travel by the vehicle anymore. Thus, the occupants will have to wait until a rescue vehicle arrives.

Patent Literature 1 discloses an automated driving system that can solve this problem. The automated driving system of Patent Literature 1 determines whether or not it is possible to drive a vehicle by the automated driving when a sensor (camera or radar) necessary for the automated driving fails. This automated driving system also stores multiple destinations. If the vehicle can be driven by the automated driving even when the sensor fails, this automated driving system selects an arriveable destination from the plurality of destinations. This reachable destination is notified to the driver.

### PRIOR ART LITERATURE

### Patent Literature

[Patent Literature 1] JP2021-111098 A

### SUMMARY OF INVENTION

### Problem to be Solved by Invention

However, the automated driving system disclosed in Patent Literature 1 changes the destination after a sensor failure occurs. In other words, this automated driving system changes the destination after the automated driving becomes impossible in a situation where the vehicle is driving toward the destination before the change. Therefore, the driving toward the destination before the change is wasted.

The inventor of the present invention came to realize that this wasted driving can be eliminated if it can be estimated in advance that the automated driving along a predefined travel route will become impossible. Thus, the present invention was made.

The purpose of the present invention is to enable an early determination of when the automated driving along a predetermined travel route becomes impossible.

### Means for Solving Problem

The solution of the present invention to achieve the aforementioned purpose presupposes an automated driving system that controls automated driving of a vehicle along a predetermined travel route. The automated driving system is then equipped with a vehicle performance estimation section, a necessary performance estimation section, and an automated driving control section. The vehicle performance estimation section estimates, at least either before the start of the automated driving or during the automated driving along the travel route, a value of a vehicle performance parameter correlating to a vehicle performance that is used to determine whether or not the automated driving is possible when the automated driving of the vehicle along the predetermined travel route is performed. The necessary performance estimation section estimates a value of a necessary performance parameter correlating to the vehicle performance required to implement the automated driving of the vehicle along the predetermined travel route. The automated driving control section implements the automated driving of the vehicle along the predetermined travel route on the condition that the value of the vehicle performance parameter is greater than or equal to the value of the necessary performance parameter. Furthermore, the automated driving control section does not implement the automated driving of the vehicle along the predetermined travel route on the condition that the value of the vehicle performance parameter is less than the value of the necessary performance parameter. This configuration results in non-implementation of the automated driving of the vehicle along the predetermined travel route if the value of an estimated vehicle performance parameter is less than the value of an estimated necessary performance parameter. In other words, it is possible to estimate in advance the situation in which the vehicle performance required to implement the automated driving of the vehicle along the predetermined travel route has not been obtained, or the situation in which there is a possibility that such necessary vehicle performance will not be obtained. This can eliminate unnecessary driving.

The vehicle performance used to determine whether or not the automated driving is possible is a heat dissipation performance of a cooling system, which dissipates heat from a device mounted in the vehicle and generating heat. The vehicle performance parameter is a heat dissipation capacity of the cooling system when the vehicle is automatically driven along the predetermined travel route. The necessary performance parameter is a necessary heat dissipation amount of the cooling system, which exceeds the amount of heat generated by the device in the case of implementing the automated driving of the vehicle along the predetermined travel route. According to this, it is possible to estimate in advance whether or not the automated driving of the vehicle along the predetermined travel route can be implemented according to the heat dissipation performance of the cooling system for dissipating the heat generated by the device. In other words, it can be estimated in advance that the automated driving along the travel route will not be able to be continued due to insufficient heat dissipation performance of the cooling system during the automated driving along the travel route.

In addition, the vehicle performance estimation section estimates the value of the vehicle performance parameter lower in accordance with the aging of the vehicle performance that is used to determine whether the automated driving is feasible or not. This allows the estimation of the value of the vehicle performance parameter according to the aging of the vehicle performance. Therefore, it is possible to accurately estimate over a long period of time whether or not the vehicle performance required to implement the automated driving of the vehicle along the predetermined travel route is obtained.

The automated driving system is also provided with a route re-setting section. When the value of the vehicle performance parameter is less than the value of the necessary performance parameter, this route re-setting section sets, as a target driving route for which the automated driving of the vehicle is controlled, a travel route that is different from the predetermined travel route and where the value of the vehicle performance parameter is greater than or equal to the value of the necessary performance parameter. As a result, even if the automated driving of the vehicle along the originally scheduled travel route is not performed, the automated driving of the vehicle can be performed on a travel route different from the scheduled travel route. In other words, it is possible to eliminate the situation where the occupants cannot move until a rescue vehicle arrives when the automated driving of the vehicle along the originally planned travel route is not performed.

The automated driving system is also equipped with a driving condition presentation section. When the value of the vehicle performance parameter is less than the value of the necessary performance parameter, this driving condition presentation section presents, to the vehicle user, a driving condition that is different from the driving condition of the predetermined travel route and in which the value of the vehicle performance parameter is greater than or equal to the value of the necessary performance parameter. This allows the vehicle user to select a driving route that is different from the predetermined travel route, even if the automated driving of the vehicle along the predetermined travel route is not performed. In other words, even if the vehicle is not automatically driven along the predetermined travel route, the automated driving of the vehicle can be performed on the selected driving route that the vehicle user desires.

### Advantageous Effects of Invention

In the present invention, if the value of the vehicle performance parameter correlating to the vehicle performance used to determine whether the automated driving is possible or not is less than the value of the necessary performance parameter correlating to the vehicle performance required to implement the automated driving, the automatic driving of the vehicle along the predetermined travel route is not implemented. This allows an early determination to be made when the automated driving along a predetermined travel route becomes impossible.

### BRIEF DESCRIPTION OF DRAWINGS

FIG. 1 is a block diagram showing a schematic configuration of an automated driving system mounted on a vehicle according to an embodiment.

FIG. 2A is a circuit diagram schematically showing a battery cooling system installed in a vehicle of the embodiment, and FIG. 2B is a circuit diagram schematically showing a high temperature cooling circuit in the battery cooling system.

FIG. 3A is a graph showing an example of the relationship between an estimated heat dissipation capacity and an estimated heat generation amount, and FIG. 3B is a graph showing an example of the relationship between the estimated heat dissipation capacity and the estimated heat generation amount in the case of reduced heat dissipation performance.

FIG. 4 is a flowchart diagram showing a procedure of the automated driving availability determination process.

FIG. 5 is a block diagram showing the schematic configuration of the automated driving system installed in a vehicle according to a variant example.

FIG. 6A to 6E are a circuit diagram schematically showing multiple redundant design examples of the battery cooling system.

### DESCRIPTION OF EMBODIMENTS

The following is a description of an embodiment of the invention based on the drawings. This embodiment describes a case in which the invention is applied to an electric vehicle. However, the invention is not limited to application to the electric vehicles. The invention can also be applied to engine-powered vehicles (conventional, hybrid, and plug-in hybrid vehicles) and fuel cell vehicles. This embodiment also describes a case where the invention is applied to an automated vehicle whose travel route is set by a navigation system. The invention can also be applied to an automated vehicle for which a travel route is set according to destination setting information transmitted from a vehicle management center.

Furthermore, in this embodiment, the following are estimated: a heat dissipation capacity (i.e. an amount of heat that can be dissipated) as the heat dissipation performance of the vehicle, and a necessary heat dissipation amount required to implement the automated driving of the vehicle along a travel route. A case in which the possibility of the automated driving is determined based on these kinds of estimated information is described as an example. The heat dissipation capacity corresponds to the “vehicle performance parameter correlating to a vehicle performance used to determine whether the automated driving of the vehicle is possible or not when the automated driving is implemented along a predetermined travel route” of the present invention. The necessary heat dissipation amount corresponds to the “necessary performance parameter correlating to a vehicle performance required to implement the automated driving of the vehicle along the planned travel route” of the present invention.

### —Automated Driving System—

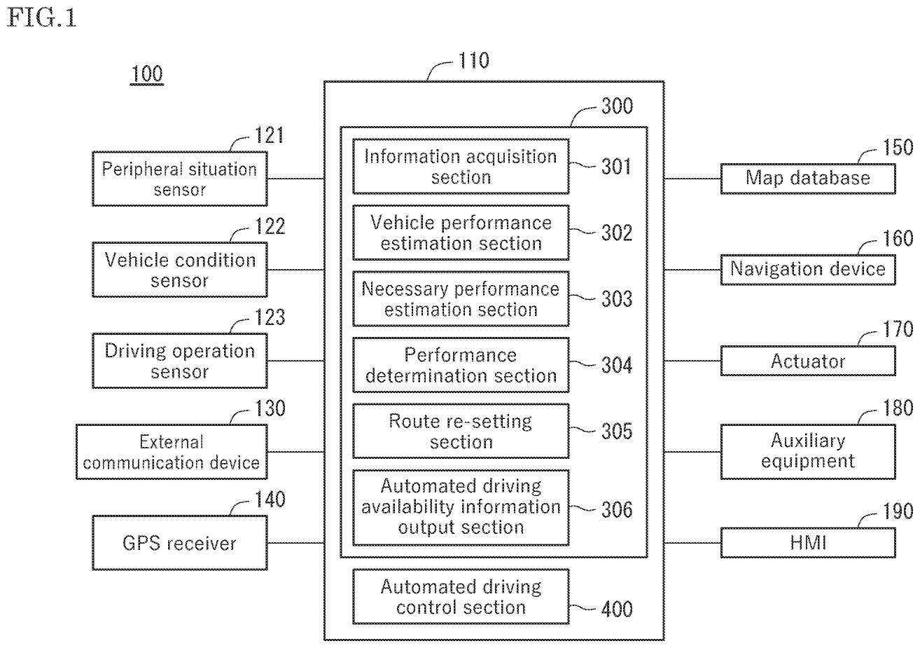

First, a brief description of the automated driving system will be given. FIG. 1 shows a schematic diagram of an automated driving system 100 installed in a vehicle according to this embodiment. As shown in FIG. 1, the automated driving system 100 of this embodiment is equipped with an automated driving ECU 110 that serves as a center of control for the automated driving of a vehicle. The following are connected to this automated driving ECU 110: a peripheral situation sensor 121; a vehicle condition sensor 122 a driving operation sensor 123; an external communication device 130; a GPS receiver 140; a map database 150; a navigation device 160; an actuator 170; auxiliary equipment 180; and an HMI (Human Machine Interface) 190.

The peripheral situation sensor 121 acquires information about the situation around the vehicle (hereinafter sometimes referred to as “own vehicle”). This information about the situation around the own vehicle includes information about the road in front of the own vehicle and obstacles around the own vehicle. The peripheral situation sensor 121 is equipped with, for example, a camera, a LIDAR, a millimeter wave radar sensor, and the like. The sensor 121 does not necessarily need to be equipped with all of these, and may also be equipped with another component, as long as it is a sensor capable of detecting the surrounding situations necessary for the automated driving. The peripheral situation sensor 121 also includes an outside air temperature sensor and the like. The peripheral situation sensor 121 transmits the acquired information to the automated driving ECU 110. The vehicle condition sensor 122 includes, for example, a vehicle speed sensor, a front/rear acceleration sensor, a lateral acceleration sensor, and a yaw rate sensor. The vehicle condition sensor 122 transmits information on detection results to the automated driving ECU 110. The driving operation sensor 123 detects the amount of operation in a situation where the automated driving is deactivated. The driving operation sensor 123 includes, for example, an accelerator operation amount sensor, a brake operation amount sensor, a brake switch, a steering angle sensor, and a shift position sensor. The driving operation sensor 123 transmits information on the detection results to the automated driving ECU 110. The external communication device 130 is a device that communicates between the own vehicle and the outside of the own vehicle. The external communication device 130 acquires information on the surrounding environment of the own vehicle. For example, the external communication device 130 acquires traffic information and other information about the vehicle's driving environment through communication with an information center. The external communication device 130 also acquires traffic information, etc. through roadside-to-vehicle communication, which is communication between the external communication device 130 and roadside equipment installed on the road. The external communication device 130 also acquires traffic information, etc. by inter-vehicle communication, which is communication between the external communication device 130 and an external communication device 130 installed in another vehicle. The external communication device 130 transmits the acquired surrounding environment information to the automated driving ECU 110. The GPS receiver 140 receives signals from GPS satellites and measures the position of the own vehicle. The GPS receiver 140 transmits the own vehicle position information as the measurement result to the automated driving ECU 110. The map database 150 is a database with map information. The database is stored in a storage device such as a hard disk installed in the own vehicle. The map information includes, for example, information on the location of roads, information on the shape of roads, information on the location of intersections and junctions, information on road types (information that can distinguish between automobile-only roads, highways, general roads, etc.), and information indicating the number of lanes. The navigation device 160 generates information on a travel route that guides the own vehicle to a destination set by an occupant. The navigation device 160 calculates the travel route to the destination based on the current position information of the own vehicle detected by the GPS receiver 140 and the map information in the map database 150. The navigation device 160 transmits the information about the travel route to the automated driving ECU 110 as navigation information. The navigation device 160 is also equipped with a point registration function for registering arbitrary points. When the automated driving is not implemented (when the vehicle is driven by the driver's operation), the navigation device 160 provides guidance to the driver to the destination using a display and a speaker, which are not shown in the Figure.

The actuator 170 includes a driving force actuator, a brake actuator, and a steering actuator. The driving force actuator is a driving motor and a motor drive circuit that controls the energizing of the driving motor. The brake actuator is, for example, a hydraulic friction braking mechanism and a hydraulic control circuit that controls the hydraulic pressure of the wheel cylinders of the hydraulic friction braking mechanism when the own vehicle's brake system is hydraulic. The steering actuator is a steering motor incorporated in the steering mechanism and a motor drive circuit that controls the energizing of the steering motor, when the own vehicle is equipped with an electric power steering system. The automated driving ECU 110 sends a driving force control signal to the driving force actuator according to the target driving force. This causes the target driving force to be generated by the driving motor. The automated driving ECU 110 also sends a braking force control signal according to the target braking force to the brake actuator. As a result, the target braking force is generated by the brake system. The automated driving ECU 110 also sends a steering control signal according to the target steering torque (or target steering angle) to the steering actuator. As a result, the target steering torque is generated by the electric power steering system. The above operations result in the automated driving of the vehicle.

Auxiliary equipment 180 is a generic term for equipment not included in the actuator 170. The auxiliary equipment 180 includes, for example, blinkers, headlamps, windshield wipers, and the like. The automated driving ECU 110 outputs an activation signal to the auxiliary equipment 180. Thereby, the operation of the auxiliary equipment 180 is controlled. The HMI 190 is an interface, with which the occupant and the automated driving system 100 input and output information. The HMI 190 is configured, for example, by: a display for displaying character information or image information; a speaker and a buzzer for generating sound; and operation buttons, a touch panel, a microphone, etc. for input operations by the occupant.

The automatic operation ECU 110 has, for example, a processor such as a CPU, a ROM for storing control programs, a RAM for temporarily storing data, and input/output ports. When the automated driving ECU 110 performs the automated driving, the automated driving ECU 110 monitors the surroundings of the own vehicle based on the information provided by the peripheral situation sensor 121. Meanwhile, the automated driving ECU 110 controls the operation of the actuator 170 so that the own vehicle can travel safely along the set travel route. The automated driving ECU 110 has an automated driving availability determination section 300 and an automated driving control section 400. The automated driving availability determination section 300 and the automated driving control section 400 are functional sections realized by the control programs described above. The automated driving availability determination section 300 has a function to determine whether or not a predetermined travel route can be traveled. The automated driving control section 400 controls the automated driving of the vehicle according to the determination of the automated driving availability determination section 300. These automated driving availability determination section 300 and automated driving control section 400 are described later.

### —Battery Cooling System—

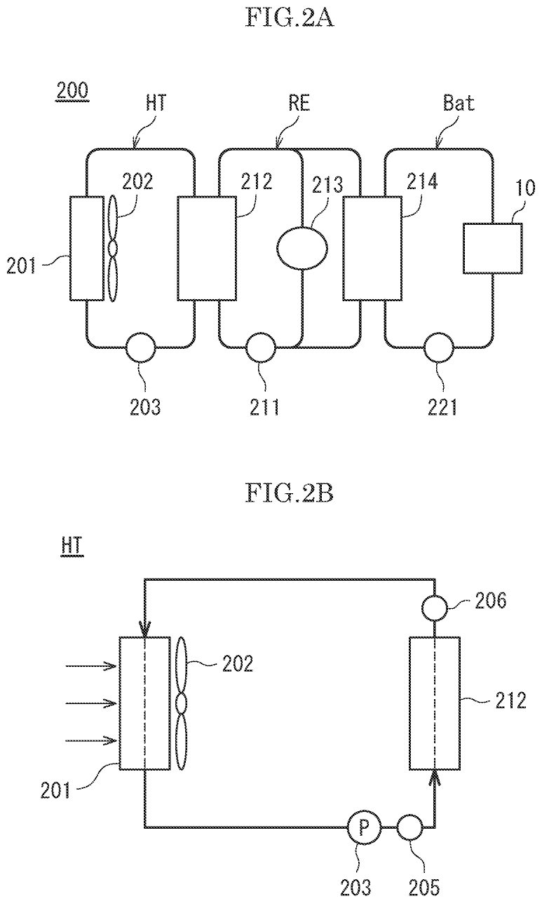

Next, the battery cooling system for cooling the battery (a device that generates heat) that supplies power to each of the above-mentioned motors is described. In this embodiment, the heat dissipation performance of the battery cooling system corresponds to the “vehicle performance used to determine whether the automated driving is possible” of the present invention. In other words, when the heat dissipation performance of the battery cooling system is estimated to be sufficiently high (i.e., when the heat dissipation performance for cooling the battery is estimated to be sufficiently high for implementing the automated driving), the implementation of the automated driving (implementation of the automated driving of the vehicle along the predetermined travel route) is determined to be possible. On the other hand, if the performance of the battery cooling system is estimated to be insufficient (when the heat dissipation performance to cool the battery is estimated to be insufficient for implementing the automated driving) or if the performance of the battery cooling system is estimated to be potentially insufficient (when it is estimated that the heat dissipation performance to cool the battery may become insufficient during automated driving), it is determined that the automated driving is not feasible. The configuration and operation for these determinations are described later. FIG. 2A is a schematic circuit diagram of a battery cooling system 200. The battery cooling system 200 cools a battery 10 installed in the vehicle. As shown in FIG. 2A, the battery cooling system 200 has a high-temperature cooling circuit HT, a refrigerant circuit RE, and a battery circuit Bat. The high-temperature cooling circuit HT is a circuit that circulates coolant. The high-temperature cooling circuit HT is a circulation circuit, which consists of a radiator 201, an electric radiator fan 202, a water pump 203, and a water cooling condenser 212 connected by piping. The radiator 201 dissipates heat from the cooling water to the outside of the vehicle. The electric radiator fan 202 provides forced airflow to the radiator 201. The water pump 203 circulates the cooling water in the high temperature cooling circuit HT. The water cooling condenser 212 exchanges heat between the cooling water and the refrigerant. The cooling water circulates in the high temperature cooling circuit HT. The refrigerant circulates in the refrigerant circuit RE.

As shown in FIG. 2B, the high temperature cooling circuit HT has a flow sensor 205 and a temperature sensor 206. The flow sensor 205 detects the flow rate of the cooling water. The temperature sensor 206 detects the temperature of the cooling water (e.g., the temperature of the cooling water at the outlet side of the water cooling condenser 212). Each piece of information detected by these sensors is transmitted to the automated driving ECU 110. The information on the rotation speed of the electric radiator fan 202 is also transmitted to the automated driving ECU 110. The refrigerant circuit RE is a circuit that circulates refrigerant while changing its phase. As shown in FIG. 2A, the refrigerant circuit RE is a circulation circuit, which consists of a compressor 211, the water cooling condenser 212, a cooler 213, and a chiller 214 connected by piping. The compressor 211 compresses the refrigerant. In the water cooling condenser 212, the refrigerant exchanges heat with the cooling water in the high-temperature cooling circuit HT. This heat exchange condenses the refrigerant, and heat from the refrigerant is dissipated into the cooling water in the high temperature cooling circuit HT. Part of the refrigerant condensed in the water cooling condenser 212 expands in the cooler 213. This cools the air surrounding the cooler 213. Another part of the refrigerant condensed in the water cooling condenser 212 expands in the chiller 214. This absorbs heat from the cooling water circulating in the battery circuit Bat (cooling the cooling water). The battery circuit Bat is a circuit that circulates cooling water to cool the battery 10. The battery circuit Bat is a circulating circuit, which is constituted of a water pump 221, the chiller 214, and the battery 10 (coolant pathway provided in the battery 10) connected by piping. The water pump 221 circulates the cooling water in the battery circuit Bat. The cooling water cooled by the chiller 214 is introduced into the battery 10. This absorbs heat from the battery 10 (cooling the battery 10). The battery 10 generates heat as it charges and discharges electricity. In order to start or continue the automated driving of the vehicle, the temperature of battery 10 must be maintained at a predetermined temperature or below. Since the battery 10 is cooled by the operation of the battery cooling system 200 described above, the heat dissipation performance in each circuit HT, RE, and Bat must be sufficient to start or continue the automated driving. In this embodiment, it is estimated in advance whether this heat dissipation performance is sufficiently secured or not. This pre-estimation does not only include estimation before the start of the automated driving. The pre-estimation also includes estimation at the stage before a deficiency in the heat dissipation performance occurs during driving along the travel route after the automated driving has been started. In the following, among the estimation of the heat dissipation performance of each circuit HT, RE, and Bat, the estimation of the heat dissipation performance of the high temperature cooling circuit HT is explained. In addition, the following describes the case in which the possibility of the automated driving is determined based on the heat dissipation performance of the high temperature cooling circuit HT. The heat dissipation performance of the refrigerant circuit RE and the battery circuit Bat are also estimated in the same way, and whether the automated driving is possible or not is determined based on the heat dissipation performance of the refrigerant circuit RE and the battery circuit Bat.

The following is a description of the automated driving availability determination section 300, which determines whether the automated driving is possible or not by estimating the heat dissipation performance of the high temperature cooling circuit HT. As shown in FIG. 1, the automated driving availability determination section 300 has an information acquisition section 301, a vehicle performance estimation section 302, a necessary performance estimation section 303, a performance determination section 304, a route re-setting section 305, and an automated driving availability information output section 306.

The information acquisition section 301 acquires information for estimating the heat dissipation performance of the high temperature cooling circuit HT. This heat dissipation performance includes not only the heat dissipation performance at the present time, but also the heat dissipation performance when the vehicle is automatically driven along the predetermined travel route. This information includes the cooling water flow rate, the cooling water temperature, the vehicle speed, the rotation speed of the electric radiator fan 202, and the outside air temperature. The cooling water flow rate is information output from the flow sensor 205. The cooling water temperature is information output from the temperature sensor 206. The vehicle speed is information output from the vehicle speed sensor. The information on the vehicle speed includes information on the vehicle speed at each point (scheduled vehicle speed) in the case of the automated driving of the vehicle along the predetermined travel route. The rotation speed of the electric radiator fan 202 is information recognized from the control signal of the electric radiator fan 202. The outside air temperature is information output from the outside air temperature sensor. The outside air temperature information also includes information on the outside air temperature at each location when the vehicle is automatically driven along the predetermined travel route. This information is, for example, information on the outside air temperature obtained by the external communication device 130.

The vehicle performance estimation section 302 estimates the heat dissipation performance of the high temperature cooling circuit HT based on the respective pieces of information obtained by the information acquisition section 301. Specifically, not only does it estimate the heat dissipation performance of the high temperature cooling circuit HT at the present time (e.g., before the start of the automated driving), but also the heat dissipation capacity as the heat dissipation performance. This heat dissipation capacity refers to the heat dissipation capacity as the heat dissipation performance of the high temperature cooling circuit HT when the vehicle is automatically driven along the predetermined travel route. This heat dissipation capacity corresponds to the “value of the vehicle performance parameter correlating to the vehicle performance used to determine whether the automated driving is possible or not” of the present invention. For example, the higher the flow rate of the cooling water, the larger the heat dissipation capacity (i.e. the value of the vehicle performance parameter). The lower the temperature of the cooling water, the larger the heat dissipation capacity. The higher the vehicle speed, the greater the heat dissipation using the running wind, and thus the greater the heat dissipation capacity to be obtained. The higher the rotation speed of the electric radiator fan 202, the larger the heat dissipation capacity. The lower the outside air temperature, the greater the amount of heat dissipated by the radiator 201, and thus the greater the heat dissipation capacity that can be obtained. The relationship between the heat dissipation capacity and the above-mentioned factors can be obtained in advance through experiments or simulations. The above-mentioned factors are the flow rate of the cooling water, the temperature of the cooling water, the vehicle speed, the rotation speed of the electric radiator fan 202, and the outside air temperature. The above relationships obtained are stored in the ROM of the automated driving ECU 110 as the heat dissipation capacity MAP. This estimation of the heat dissipation capacity is performed at the timing when the travel route to the destination is set. This estimation of the heat dissipation capacity is also continuously performed during the automated driving along the travel route.

The necessary performance estimation section 303 acquires information on the travel route (travel route to the destination) set by the navigation device 160. The necessary performance estimation section 303 then estimates, as the necessary heat dissipation performance, the heat dissipation performance of the high temperature cooling circuit HT required to reach the destination based on the information on the travel route. Specifically, the output (required motor output), the current flow (required current flow to obtain the required motor output), and the vehicle speed (vehicle speed when traveling at the required output) at each point along the travel route are estimated from the travel route information. The necessary heat dissipation performance is estimated to be the heat dissipation performance at which the heat dissipation capacity (necessary heat dissipation capacity) exceeds the amount of heat generated (estimated heat generation amount) when the vehicle is assumed to travel along the travel route at these output, power flow rate, and vehicle speed. This necessary heat dissipation capacity corresponds to “the value of the necessary performance parameter correlating to the vehicle performance required to implement the automated driving of the vehicle” of the present invention. For example, the higher the power output is, the larger the value of the necessary heat dissipation capacity (the value of the necessary performance parameter) is set. The higher the current flow rate is, the higher the value of the necessary heat dissipation capacity is set. As to the vehicle speed, the necessary heat dissipation capacity is set based on the relationship between the amount of heat dissipation by the cooling water caused by the running wind passing through the radiator 201 and the amount of heat generated by the battery 10 in accordance with the vehicle speed. These relationships between the necessary heat dissipation capacity and the output/current flow/vehicle speed are determined in advance through experiments and simulations, and stored in the ROM of the automated driving ECU 110 as the necessary heat dissipation capacity MAP. This estimation of the necessary heat dissipation capacity is also performed not only at the timing when the travel route to the destination is set, but also continuously performed during automated driving along the travel route.

The performance determination section 304 compares the heat dissipation capacity with the necessary heat dissipation capacity. The heat dissipation capacity is a value of the vehicle performance parameter and is estimated by the vehicle performance estimation section 302. The necessary heat dissipation capacity is a value of the necessary performance parameter and is estimated by the necessary performance estimation section 303. Specifically, the comparison of the heat dissipation capacity with the necessary heat dissipation capacity is performed at predetermined timings. The predetermined timings include a predetermined timing before the start of the automated driving and a predetermined timing during the implementation of the automated driving of the vehicle along the travel route. If the value of the vehicle performance parameter is greater than or equal to the value of the necessary performance parameter at each comparison timing, the performance determination section 304 determines that the heat dissipation performance of the high temperature cooling circuit HT is sufficient. In other words, the performance determination section 304 determines that the vehicle can be automatically driven along the travel route on the condition that the heat dissipation performance of the other circuits (the refrigerant circuit RE and the battery circuit Bat) is sufficiently secured. In this case, the performance determination section 304 outputs the automated driving availability information to the automated driving availability information output section 306. Upon receiving this automated driving availability information, the automated driving availability information output section 306 outputs command information to the automated driving control section 400. This command information is information for implementing the automated driving along the travel route. This causes the automated driving ECU 110 to send a control signal to the actuator 170 to implement the automated driving of the vehicle.

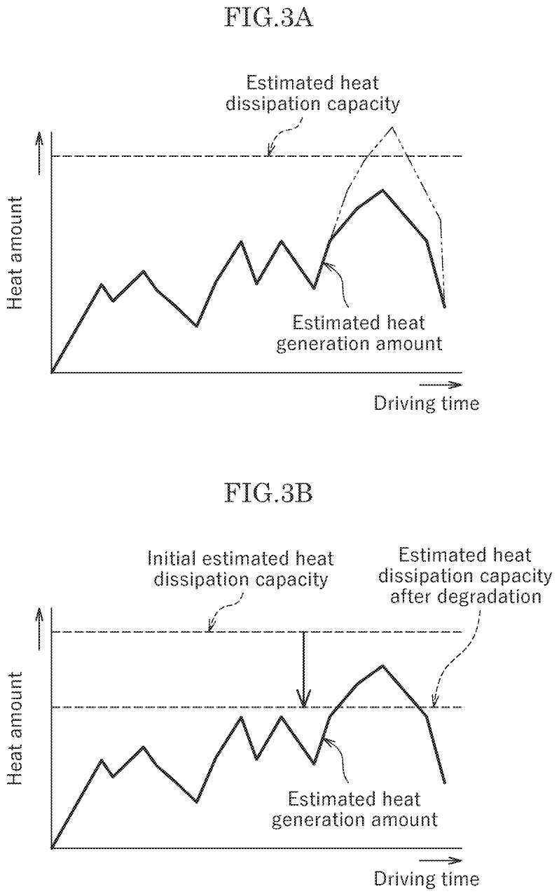

FIG. 3A is a graph showing an example of the relationship between the estimated heat dissipation capacity and the estimated heat generation amount (e.g., the amount of heat generated by the battery 10) in the case where the automated driving is assumed to be performed along the travel route. The necessary heat dissipation capacity is set to be equal to or slightly greater than the estimated heat generation amount. In the state of heat generation amount shown by the solid line in FIG. 3A, the estimated heat dissipation capacity (the value of the vehicle performance parameter) is equal to or greater than the estimated heat generation amount (equivalent to the estimated necessary heat dissipation capacity (the value of the necessary performance parameter)). In this case, it is determined that the automated driving of the vehicle along the travel route is possible, provided that the heat dissipation performance of the other circuits (the refrigerant circuit RE and the battery circuit Bat) is sufficient. In FIG. 3A, the estimated heat dissipation capacity is constant over the entire driving time, but in reality, the heat dissipation capacity may change in accordance with changes in the outside air temperature, the vehicle speed, etc. In addition, the performance of each component constituting the high-temperature cooling circuit HT deteriorates over time. Therefore, as shown in FIG. 3B, the vehicle performance estimation section 302 sets the heat dissipation capacity (the value of the vehicle performance parameter) lower according to this aging (see the initial estimated heat dissipation capacity and the estimated heat dissipation capacity after degradation in FIG. 3B). The degree of decrease in the heat dissipation capacity over time is determined in advance through experiments and simulations. The performance of each component constituting the high-temperature cooling circuit HT deteriorates not only with age, but also due to malfunction or damage. For example, this occurs when a vehicle is subjected to a minor collision. The vehicle performance estimation section 302 sets the reduction in the heat dissipation capacity of the high temperature cooling circuit HT according to the load during a light collision. On the other hand, if the value of the vehicle performance parameter is less than the value of the necessary performance parameter, the performance determination section 304 determines that the heat dissipation performance of the high temperature cooling circuit HT may be insufficient. In other words, even if the heat dissipation performance of the other circuits (the refrigerant circuit RE and the battery circuit Bat) is sufficient, the performance determination section 304 determines that the automated driving of the vehicle along the travel route is not possible. In other words, it determines in advance that the heat dissipation performance of the high-temperature cooling circuit HT is insufficient in the preliminary stage of reaching the destination and that the automated driving cannot be continued. In this case, the performance determination section 304 outputs route re-setting instruction information to the route re-setting section 305.

In the state of estimated heat generation amount shown in FIG. 3A by the dashed double-dotted line, there is a period of time when the estimated heat dissipation capacity is less than the estimated heat generation amount. In this case, even if the heat dissipation performance of the other circuits (the refrigerant circuit RE and the battery circuit Bat) is sufficient, the automated driving of the vehicle along the travel route is determined to be impossible.

When the route re-setting section 305 receives the route re-setting instruction information from the performance determination section 304, it re-sets the travel route. In other words, since the automated driving of the vehicle along the initial travel route is impossible, the travel route is re-set so that the automated driving can be performed along a different travel route from the initial travel route. The driving mode of the travel route to be re-set here includes detour driving, return driving, and evacuation driving.

Detour driving is driving when the automated driving of the vehicle along the initial travel route is not possible, but the destination can be reached by changing the travel route (driving on a detour route). In other words, when the route re-setting section 305 receives the route re-setting instruction information from the performance determination section 304, it searches for a detour route to reach the destination and outputs this detour route to the vehicle performance estimation section 302 and the necessary performance estimation section 303. At this time, the vehicle performance estimation section 302 estimates the heat dissipation capacity (the value of the vehicle performance parameter) assuming that the vehicle travels on this detour route. The necessary performance estimation section 303 estimates the necessary heat dissipation capacity (the value of the necessary performance parameter) assuming that the vehicle travels on this detour route. Then, the performance determination section 304 compares the heat dissipation capacity (the value of the vehicle performance parameter) and the necessary heat dissipation capacity (the value of the necessary performance parameter), and if the value of the vehicle performance parameter is equal to or higher than the value of the necessary performance parameter, it is determined that the destination can be reached by re-setting the detour route as the travel route. The performance determination section 304 then outputs the automated driving availability information to the automated driving availability information output section 306. For example, in a situation where the battery 10 generates a large amount of heat due to many uphill roads in the initial travel route and the heat dissipation performance of the high temperature cooling circuit HT is insufficient, it is assumed that a detour route with many flat roads is taken. This is because it is assumed that by traveling on the aforementioned detour route, the amount of heat generated by the battery 10 is reduced and the heat dissipation performance of the high-temperature cooling circuit HT is sufficiently secured. The automated driving availability information output section 306, which received the automated driving availability information, outputs command information to the automated driving control section 400 to implement the automated driving along the detour route. As a result, the automated driving ECU 110 sends a control signal to the actuator 170 to implement the automated driving of the vehicle (traveling along the detour route). During driving along the detour route also, the heat dissipation capacity (the value of the vehicle performance parameter) is compared with the necessary heat dissipation capacity (the value of the necessary performance parameter), and if the value of the vehicle performance parameter is estimated to be less than the value of the necessary performance parameter (for example, if the heat dissipation capacity is reduced due to an increase in the outside air temperature), the driving along the detour route is stopped.

The return driving is driving to return the vehicle to a repair shop, for example, for maintenance of the high temperature cooling circuit HT. If the automated driving of the vehicle along the initial travel route is no longer possible, it is due to insufficient heat dissipation performance of the high temperature cooling circuit HT. Thus, it is assumed that the high temperature cooling circuit HT has deteriorated or failed. Therefore, it is necessary to return the vehicle to a repair shop or other facility to maintain the high temperature cooling circuit HT. When the route re-setting instruction information is received from the performance determination section 304, or when the aforementioned detour route cannot be retrieved, or when a detour route that can ensure the heat dissipation performance of the high temperature cooling circuit HT cannot be set, the route re-setting section 305 retrieves a return route to reach a return point such as a repair shop, etc. and outputs this return route to the vehicle performance estimation section 302 and the necessary performance estimation section 303. At this time, the vehicle performance estimation section 302 estimates the heat dissipation capacity (the value of the vehicle performance parameter) assuming that the vehicle travels along this return route. The necessary performance estimation section 303 estimates the necessary heat dissipation capacity (the value of the necessary performance parameter) assuming that the vehicle travels along this return route. Then, the performance determination section 304 compares the heat dissipation capacity (the value of the vehicle performance parameter) with the necessary heat dissipation capacity (the value of the necessary performance parameter), and if the value of the vehicle performance parameter is equal to or higher than the value of the necessary performance parameter, it is determined that the return route can be re-set as the travel route to reach the return point. The performance determination section 304 then outputs the automated driving availability information to the automated driving availability information output section 306. The automated driving availability information output section 306 that receives the automated driving availability information outputs command information to the automated driving control section 400 to implement the automated driving along the return route. As a result, the automated driving ECU 110 sends a control signal to the actuator 170 to implement the automated driving of the vehicle (traveling along the return route). During driving along the return route, the heat dissipation capacity (the value of the vehicle performance parameter) is compared with the necessary heat dissipation capacity (the value of the necessary performance parameter), and if the value of the vehicle performance parameter is estimated to be less than the value of the necessary performance parameter (for example, if the heat dissipation capacity is reduced due to an increase in the outside air temperature), the driving along the return route is stopped.

If it is estimated that the value of the vehicle performance parameter will be less than the value of the necessary performance parameter in any of the detour driving and return driving, the route re-setting section 305 determines that the detour driving and the return driving are not possible. In this case, the evacuation driving is performed. In other words, the performance determination section 304 outputs the evacuation driving information to the automated driving availability information output section 306. Upon receiving the evacuation driving information, the automated driving availability information output section 306 outputs command information to the automated driving control section 400 to execute evacuation driving. As a result, a control signal is sent from the automated driving ECU 110 to the actuator 170 to control the vehicle to travel to the shoulder of the road by evacuation driving, and then to stop the vehicle. In this case, rescue request information is transmitted by the external communication device 130 and the vehicle waits for the arrival of a rescue vehicle.

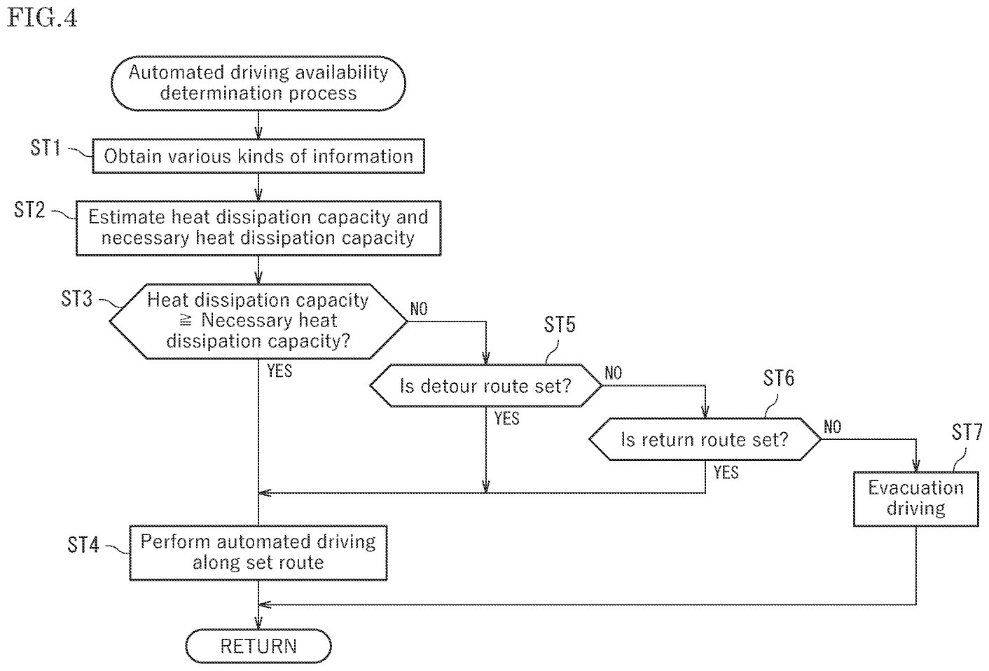

Next, the procedure of the automated driving availability determination process carried out by the aforementioned automated driving availability determination section 300 will be described according to the flowchart in FIG. 4. This flowchart is executed when a travel route (travel route to a destination) is set by the navigation device 160, and also during the automated driving in the case where the automated driving of the vehicle along the travel route is started. Here again, the case will be taken as an example, in which the start or continuation of the automated driving is determined according to whether the heat dissipation performance of the high temperature cooling circuit HT is sufficient or not. First, in step ST1, various kinds of information used for determining whether the automated driving is possible or not are obtained. For example, information such as the detected cooling water flow rate, the cooling water temperature, the vehicle speed, the rotation speed of the electric radiator fan 202, and the outside air temperature is acquired. In addition, information such as the power output, the current flow rate, and the vehicle speed at each point in the travel route is acquired. In step ST2, the heat dissipation capacity (the value of the vehicle performance parameter) is estimated by the vehicle performance estimation section 302. The necessary heat dissipation capacity (the value of the necessary performance parameter) is also estimated by the necessary performance estimation section 303. The procedure then moves to step ST3 to determine whether the heat dissipation capacity is greater than or equal to the necessary heat dissipation capacity. If it is determined to be “YES” in step ST3, the procedure moves to step ST4, where it is determined that the heat dissipation performance of the high temperature cooling circuit HT is sufficient. Then, the automated driving of the vehicle along the travel route is carried out on the condition that the heat dissipation performance of the other circuits (the refrigerant circuit RE and the battery circuit Bat) is sufficiently secured. If it is determined to be “NO” in step ST3, the procedure moves to step ST5 to determine whether a detour route is set as the travel route. In other words, whether or not the detour route has been re-set as a travel route is determined by whether or not the heat dissipation capacity when the vehicle is assumed to be traveled along the detour route retrieved by the route re-setting section 305 is greater than or equal to the necessary heat dissipation capacity. If it is determined to be “YES” in step ST5, the system moves to step ST4 and performs the automated driving of the vehicle along the detour route. If it is determined to be “NO” in step ST5, the system moves to step ST6 to determine whether the return route has been set as the travel route. In other words, whether or not the return route has been re-set as a travel route is determined by whether or not the heat dissipation capacity when the vehicle is assumed to be traveled along the return route retrieved by the route re-setting section 305 is greater than or equal to the necessary heat dissipation capacity. If it is determined to be “YES” in step ST6, the system moves to step ST4 and performs the automated driving of the vehicle along the return route. If it is determined to be “NO” in step ST6, it is presumed that the value of the vehicle performance parameter is less than the value of the necessary performance parameter in both the detour driving and the return driving. Therefore, since neither the detour driving nor the return driving can be performed, the vehicle is evacuated in step ST7. The above operation is repeated.

### Effects of the Embodiment

As explained above, in this embodiment, when the value of the vehicle performance parameter is estimated to be less than the value of the necessary performance parameter, the automated driving of the vehicle along the predetermined travel route is not implemented. Specifically, either detour, return, or evacuation driving is performed. This allows an early determination to be made when the automated driving along the predetermined travel route becomes impossible.

### —Variations—

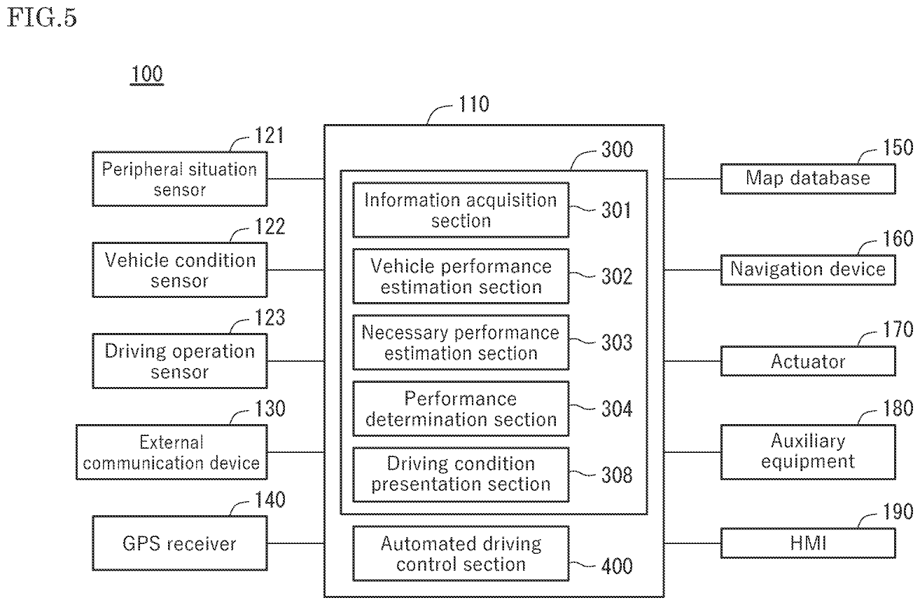

Next, a variant will be described. In the aforementioned embodiment, when the value of the vehicle performance parameter is less than the value of the necessary performance parameter, either detour, return, or evacuation driving is automatically set. Instead, this variation presents to the user optional driving conditions when the value of the vehicle performance parameter is less than the value of the necessary performance parameter, and performs the automated driving under the driving condition selected by the user among these optional driving conditions. FIG. 5 is a block diagram showing the schematic configuration of the automated driving system 100 installed in the vehicle according to this variant. In this FIG. 5, the same functional parts as those described in FIG. 1 in the aforementioned embodiment are marked with the same symbols and their descriptions are omitted.

As shown in FIG. 5, the automated driving system 100 installed in the vehicle according to this variant has a driving condition presentation section 308. When this driving condition presentation section 308 receives route re-setting instruction information from the performance determination section 304, it calculates driving conditions under which the value of the vehicle performance parameter is greater than or equal to the value of the necessary performance parameter, and presents those driving conditions to the vehicle user. One mode of presenting these driving conditions is displaying them on the aforementioned display. For example, one or more detour routes or one or more return routes are presented. The vehicle user may also be presented with information that changes the vehicle speed or the estimated time of arrival, without changing the travel route. This allows the vehicle user to set the vehicle travel conditions as desired.

### —Redundant Design Example—.

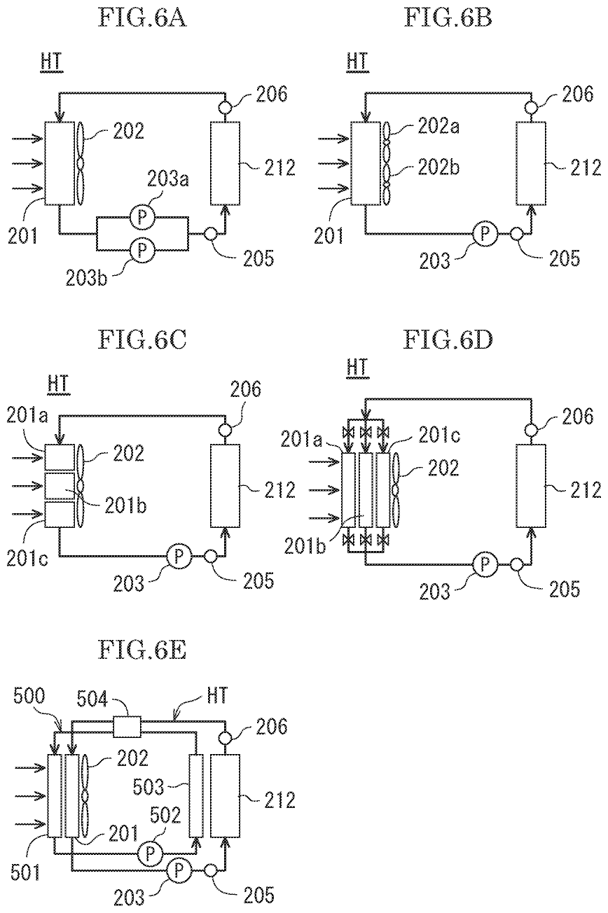

Next, multiple redundant design examples for the high-temperature cooling circuit HT to suppress insufficient heat dissipation performance of the high-temperature cooling circuit HT are described. When the components in FIG. 6A to 6E below are identical to each component of the high-temperature cooling circuit HT described using FIG. 2B in the aforementioned embodiment, the same symbols are marked and the description is omitted.

FIG. 6A shows two water pumps 203a, 203b connected in parallel. In this case, even if one water pump 203a fails, cooling water circulation is still possible through the operation of the other water pump 203b. In this case, the heat dissipation performance of the high-temperature cooling circuit HT is roughly halved. However, even when the heat dissipation performance is reduced in this way, if the value of the vehicle performance parameter is equal to or higher than the value of the necessary performance parameter, it can be determined that the automated driving of the vehicle along the travel route is possible. Thus, the automated driving of the vehicle can be implemented. FIG. 6B shows two electric radiator fans 202a, 202b installed side by side. In this case, even if one electric radiator fan 202a fails, the other electric radiator fan 202b can be activated to blow air to the radiator 201. In this case, the heat dissipation performance of the high-temperature cooling circuit HT will be halved approximately. However, even when the heat dissipation performance is reduced in this way, if the value of the vehicle performance parameter is equal to or higher than the value of the necessary performance parameter, it can be determined that the automated driving of the vehicle along the travel route is possible. Thus, the automated driving of the vehicle can be implemented. FIG. 6C shows three radiators 201a, 201b, 201c connected in series. In this case, even if one radiator 201a is damaged, heat exchange is still possible by the other two radiators 201b and 201c. In this case, the heat dissipation performance of the high-temperature cooling circuit HT will be reduced to about ⅔. However, even with this reduced heat dissipation performance, if the value of the vehicle performance parameter is equal to or higher than the value of the necessary performance parameter, it can be determined that the automated driving of the vehicle along the travel route is possible. Thus, the automated driving of the vehicle can be implemented. FIG. 6D shows three radiators 201a, 201b, 201c connected in parallel. In this case, too, if one radiator 201a is damaged, heat exchange can still be performed by the other two radiators 201b and 201c. In this case, the heat dissipation performance of the high temperature cooling circuit HT will be reduced to about ⅔, but even in this case of reduced heat dissipation performance, if the value of the vehicle performance parameter is equal to or higher than the value of the necessary performance parameter, it can be determined that the automated driving of the vehicle along the travel route is possible, and the automated driving can be implemented. In addition, valves are provided upstream and downstream of each radiator 201a, 201b, 201c. By closing these valves, the cooling water does not flow to the damaged radiator. FIG. 6E shows a configuration that allows heat exchange with other cooling circuits to compensate for the lack of heat dissipation performance of the high-temperature cooling circuit HT. Examples of the other cooling circuits include a PCU (Power Control Unit), and a cooling circuit 500. The PCU cooling circuit 500 is a circuit that circulates cooling water. The PCU cooling circuit 500 is a circulation circuit. This circulation circuit consists of a radiator 501, a water pump 502, and a PCU cooling unit 503 connected by piping. The radiator 501 is located opposite the radiator 201 in the high temperature cooling circuit HT. The radiator 501 dissipates heat from the cooling water to the outside of the vehicle. The water pump 502 circulates the cooling water in the PCU cooling circuit 500. The PCU cooling unit 503 exchanges heat between the cooling water circulating in the PCU cooling circuit 500 and the PCU. This heat exchange cools the PCU. The cooling water circulating in the high temperature cooling circuit HT and the cooling water circulating in the PCU cooling circuit 500 can exchange heat by the heat exchanger 504. Therefore, in the case of a situation where the heat dissipation performance of the high temperature cooling circuit HT is insufficient, the heat of the cooling water in the high temperature cooling circuit HT is dissipated to the cooling water in the PCU cooling circuit 500. This heat dissipation can eliminate the insufficient heat dissipation performance of the high temperature cooling circuit HT. This can eliminate the situation where the value of the vehicle performance parameter is less than the value of the necessary performance parameter. The redundant design example described above is not limited to application to the high temperature cooling circuit HT, but can also be applied to the refrigerant circuit RE and the battery circuit Bat.

### OTHER EMBODIMENTS

The present invention is not limited to the aforementioned embodiments and the aforementioned variations, but all variations and applications encompassed within the scope of the claims and the scope equivalent thereto are possible.

For example, in the above embodiments and the above variations, the heat dissipation performance of the battery cooling system 200 was taken as an example of the vehicle performance used to determine whether the automated driving is possible. The present invention is not limited thereto, but may also be applied to the heat dissipation performance of the cooling system of various motors. It may also be applied to the hydraulic pressure supply performance of the hydraulic system or the electric power supply performance of the electrical system, which is mounted on a vehicle.

### INDUSTRIAL APPLICABILITY

This invention is applicable to automated driving systems.

What is claimed is:

1. An automated driving system for controlling automated driving of a vehicle along a predetermined travel route, the automated driving system comprising:
a vehicle performance estimation section to estimate, at least either before a start of the automated driving or during the automated driving along the predetermined travel route, a value of a vehicle performance parameter correlating to a vehicle performance used to determine whether or not the automated driving is possible when the automated driving of the vehicle is performed along the predetermined travel route;
a necessary performance estimation section to estimate a value of a necessary performance parameter correlating to the vehicle performance required to implement the automated driving of the vehicle along the predetermined travel route; and
an automated driving control section to implement the automated driving of the vehicle along the predetermined travel route on a condition that the value of the vehicle performance parameter is greater than or equal to the value of the necessary performance parameter, and also not to implement the automated driving of the vehicle along the predetermined travel route on the condition that the value of the vehicle performance parameter is less than the value of the necessary performance parameter.

2. The automated driving system according to claim 1, wherein
the vehicle performance used to determine whether or not the automated driving is possible is a heat dissipation performance of a cooling system used to dissipate heat from a device mounted on the vehicle and generating heat,
the vehicle performance parameter is a heat dissipation capacity of the cooling system when the automated driving of the vehicle is implemented along the predetermined travel route, and
the necessary performance parameter is a necessary heat dissipation amount of the cooling system, and furthermore the necessary heat dissipation amount exceeds an amount of heat generated by the device when the automated driving of the vehicle is implemented along the predetermined travel route.

3. The automated driving system according to claim 1, wherein the vehicle performance estimation section sets an estimated value of the vehicle performance parameter lower as the vehicle performance used to determine whether the automated driving is possible deteriorates over time.

4. The automated driving system according to claim 1, further comprising a route re-setting section, wherein
when the value of the vehicle performance parameter is less than the value of the necessary performance parameter, the route re-setting section sets, as a target driving route for which the automated driving of the vehicle is controlled, a driving route that is different from the predetermined travel route and in which the value of the vehicle performance parameter is greater than or equal to the value of the necessary performance parameter.

5. The automated driving system according to claim 1, further comprising a driving condition presentation section, wherein
when the value of the vehicle performance parameter is less than the value of the necessary performance parameter, the driving condition presentation section presents, to a vehicle user, a driving condition that is different from the driving condition of the predetermined travel route and in which the value of the vehicle performance parameter is greater than or equal to the value of the necessary performance parameter.
